(19) United States
(12) Patent Application Publication
(10) Pub. No.: US 2003/0161530 A1
(43) Pub. Date: Aug. 28, 2003

(54) IMAGE PROCESSING APPARATUS AND METHOD, AND RECORDING MEDIUM

(76) Inventors: OSAMU YAMADA, TOYKO (JP); TAKAHIRO MATSUURA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/420,772

(22) Filed: Oct. 19, 1999

(30) Foreign Application Priority Data
Oct. 19, 1998 (JP) 10-297283

(51) Int. Cl. G06K 9/00

(52) U.S. Cl. 382/167; 382/168

(57) ABSTRACT

Generally, saturation conversion is done by multiplying data by a saturation conversion parameter with a constant value regardless of image features, an image may be saturated on the high-saturation side, or may become achromatic on the low-saturation side. Hence, in this invention, the saturation conversion parameters of an image are respectively set at the high- and low-saturation sides, and the conversion characteristics are calculated based on the plurality of saturation conversion parameters to convert saturation. In this way, appropriate saturation correction is achieved on both the high- and low-saturation sides.

### BACKGROUND OF THE INVENTION

This invention relates to an image processing apparatus and method for performing saturation conversion.

In general, an image processing apparatus for forming a multi-valued image performs so-called saturation conversion to obtain an image with appropriate saturation by compensating saturation for a less saturated area in an image, and suppressing saturation for an oversaturated area.

In order to implement saturation conversion in a conventional image processing apparatus, saturation values (normally ranging from 0.0 to 1.0) are calculated in units of pixels in an image, and the saturation value of each pixel is corrected by multiplying the saturation value by a predetermined saturation conversion parameter.

However, the conventional image processing apparatus always performs saturation conversion based on a saturation conversion parameter with a constant value regardless of the image feature of the image to be converted.

Hence, when the saturation value of each pixel of an original image is multiplied by a saturation conversion parameter with a value exceeding 1.0 in order to increase saturation, the converted saturation value of each pixel corresponding to the high-saturation side of a chromatic color area becomes a value, which also exceeds 1.0. However since the upper limit value of saturation is 1.0, the high-saturation side is saturated in this case.

On the other hand, when the saturation value of each pixel of an original image is multiplied by a saturation conversion parameter with a value less than 1.0 in order to suppress saturation, the converted saturation value of each pixel corresponding to the low-saturation side of a chromatic color area approaches zero. Since the lower limit value of saturation is 0.0 which indicates achromatic color, the low-saturation side is converted into achromatic color in this case.

### SUMMARY OF THE INVENTION

Accordingly, it is an object of the present invention to provide an image processing apparatus and method, which can implement appropriate saturation conversion in a chromatic color area, and a recording medium.

According the present invention, the foregoing object is attained by providing an image processing apparatus comprising saturation calculation means for calculating saturation information of an image; parameter setting means for setting a plurality of parameters used to convert saturation of the image; and saturation conversion means for converting the saturation of the image on the basis of the plurality of parameters.

With this arrangement, the saturation calculation means calculates saturation information of an image, the parameter setting means sets a plurality of parameters used to convert saturation of the image, and the saturation conversion means can convert the saturation of the image based on the plurality of parameters.

This invention is particularly advantageous since saturation conversion can be appropriately done in a chromatic color area.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the hardware arrangement of an image processing apparatus according to the present invention;

FIG. 2 is a diagram showing an example of the module arrangement of software according to the present invention;

FIG. 3 is a flow chart showing an outline of an image process in the present invention;

FIG. 4 is a table showing an example of data items held by a parameter holding block;

FIG. 5 is a flow chart showing a highlight/shadow calculation process;

FIG. 6 is a graph showing an example of a luminance histogram;

FIG. 7 is a flow chart showing a white/black balance calculation process;

FIG. 8 is a flow chart showing an image correction process;

FIG. 9 is a graph showing an example of the characteristics of a look-up table;

FIG. 10 is a flow chart showing a saturation conversion process;

FIG. 11 is a flow chart showing a color space conversion process;

FIG. 12 is a graph showing an example of saturation conversion characteristics;

FIG. 13 is a flow chart showing an inverse color space conversion process; and

FIG. 14 is a graph showing an example of saturation conversion characteristics in a modification of the embodiment of the present invention.

### DESCRIPTION OF THE PREFERRED EMBODIMENTS

Preferred embodiments of the present invention will now be described in detail in accordance with the accompanying drawings.

[Apparatus Arrangement]

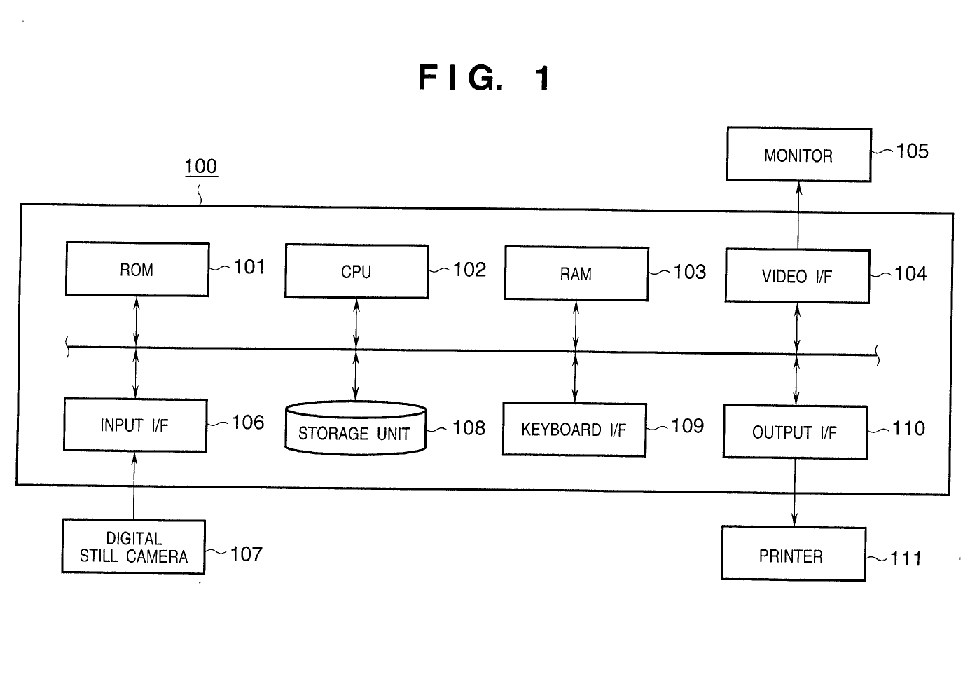

An example of the arrangement of an image processing apparatus according to an embodiment of the present invention will be described in detail hereinafter with reference to the accompanying drawings. Note that the image processing apparatus of the present invention is implemented by an apparatus comprising the hardware arrangement (e.g., a computer apparatus such as a personal computer), as shown in, e.g., FIG. 1, or by supplying software having functions (to be described later) to a dedicated computer apparatus.

Referring to FIG. 1, a CPU 102 of a computer apparatus 100 executes a program stored in a ROM 101 or storage unit 108 such as a hard disk or the like using a RAM 103 and the storage unit 108 as a work memory. The program includes at least an operating system (OS) and software for executing processes (to be described later) according to this embodiment.

Image data to be processed by the computer apparatus 100 is input from an input device such as a digital still camera 107 or the like via an input interface (I/F) 106, and is processed by the CPU 102. The processed image data is converted by the CPU 102 into a format corresponding to an output device, and is then sent to an output device such as a printer 111 or the like via an output I/F 110. The input image data, output image data, image data whose processing is underway, and the like can be stored in the storage unit 108 or can be displayed on a monitor 105 such as a CRT, LCD, or the like via a video I/F 104 as needed. These processes and operations can be designated by the user using a keyboard as an input device, a mouse as a pointing device, and the like connected to a keyboard I/F 109.

Note that the input and output I/Fs 106 and 110 can use SCSI as a versatile interface, parallel interfaces such as GPIB, Centronics, and the like, and serial interfaces such as RS232, RS422, IEEE1394, USB (Universal Serial Bus), and the like.

The storage unit 108 can use storage media such as MO, optical disks (e.g., DVD-RAM), and the like in addition to the hard disk. As a device for inputting image data, a digital video camera, image scanner, film scanner, and the like can be used in addition to the digital still camera, or image data can be input from the storage medium or via a communication medium. As a device to which image data is output, printers such as a laser beam printer, ink-jet printer, thermal printer, and the like, a film recorder, and the like can be used. Furthermore, the processed image data may be stored in the storage medium or may be output onto the communication medium.

[Functional Arrangement]

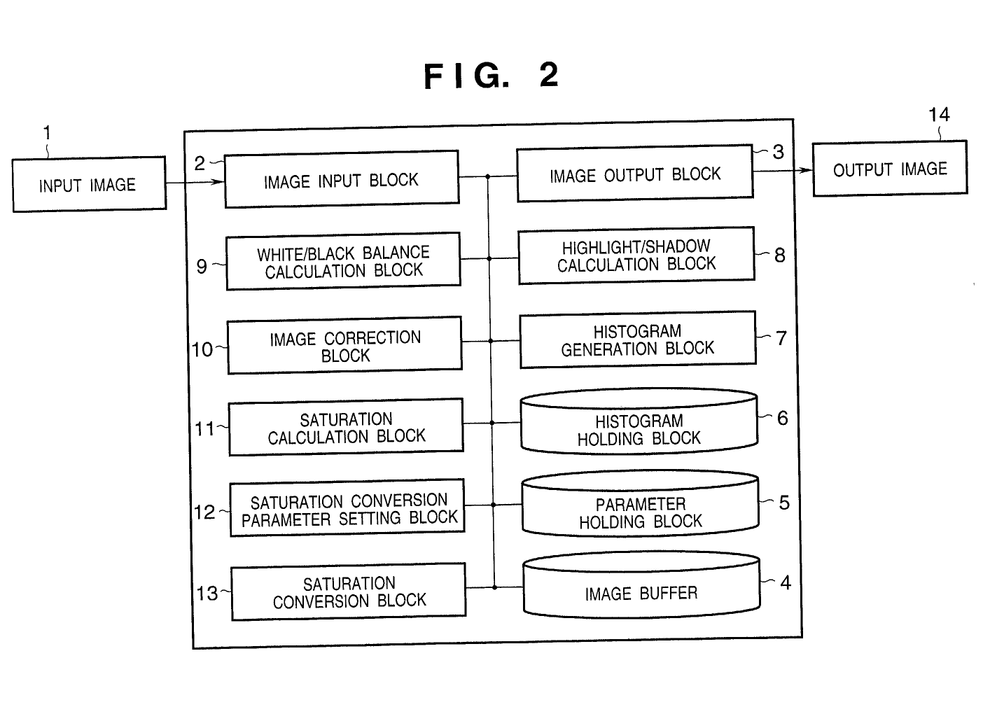

FIG. 2 is a diagram showing an example of the arrangement of function blocks (modules) of software according to this embodiment. In this embodiment, the functional arrangement that implements saturation conversion in this embodiment comprises an image input block 2, image output block 3, image buffer 4, parameter holding block 5, histogram holding block 6, histogram generation block 7, highlight/shadow calculation block 8, white/black balance calculation block 9, image correction block 10, saturation calculation block 11, saturation conversion parameter setting block 12, and saturation conversion block 13.

The image input block 2 loads an input image 1, and writes it in the image buffer 4. The parameter holding block 5 holds parameters (including saturation conversion parameters) required for correction to be described later. The histogram holding block 6 holds a histogram of image data. The histogram generation block 7 generates a histogram based on image data stored in the image buffer 4, and stores the generated histogram in the histogram holding block 6. The highlight/shadow calculation block 8 calculates highlight and shadow points on the basis of the histogram stored in the histogram holding block 6, and stores the calculated points in the parameter holding block 5. The white/black balance calculation block 9 calculates white and black balances, and stores them in the parameter holding block 5. The image correction block 10 corrects image data stored in the image buffer 4 on the basis of data stored in the parameter holding block 5.

The saturation calculation block 11 calculates the saturation of image data stored in the image buffer 4. The saturation parameter setting block 12 determines a saturation conversion parameter on the basis of saturation information of an image and user instruction, and stores the determined parameter in the parameter holding block 5. The saturation conversion block 13 converts the saturation of image data stored in the image buffer 4 using the saturation conversion parameter stored in the parameter holding block 5.

The image output block 3 reads out image data stored in the image buffer 4, and outputs it as an output image 14.

[Outline of Image Process]

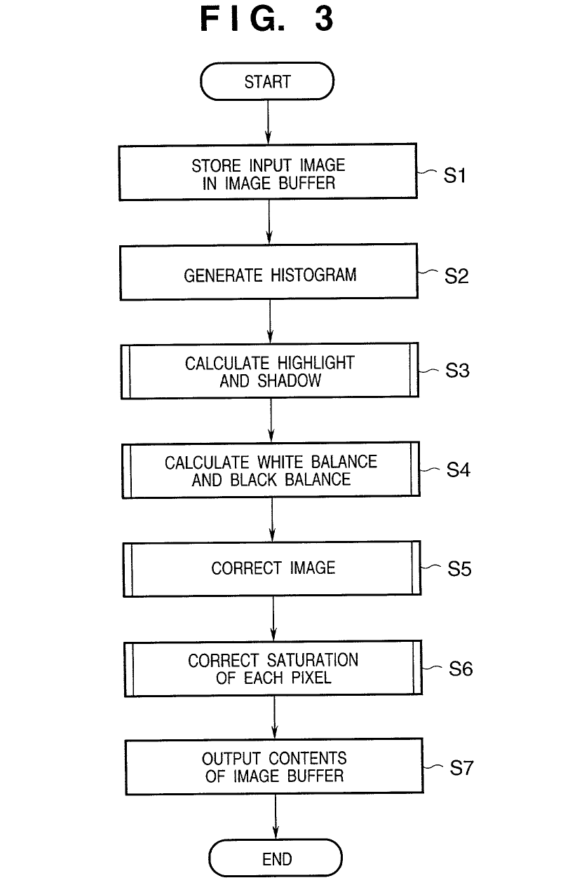

FIG. 3 is a flow chart showing an out line of an image process in this embodiment. In step S1, the image input block 2 loads an input image 1, and stores it in the image buffer 4. In step S2, the histogram generation block 7 generates a luminance histogram on the basis of the image data stored in the image buffer 4, and stores the generated histogram in the histogram holding block 6.

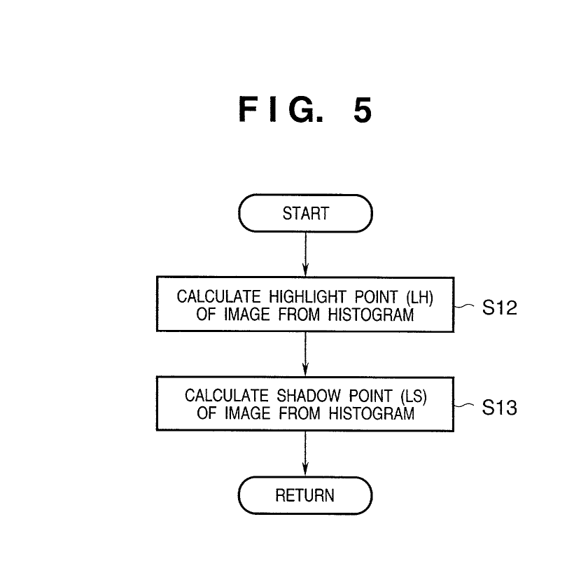

In step S3, the highlight/shadow calculation block 8 calculates highlight and shadow points of the image on the basis of the luminance histogram stored in the histogram holding block 6. Note that the operation of the highlight/shadow calculation block 8 will be described in detail later with reference to FIG. 5.

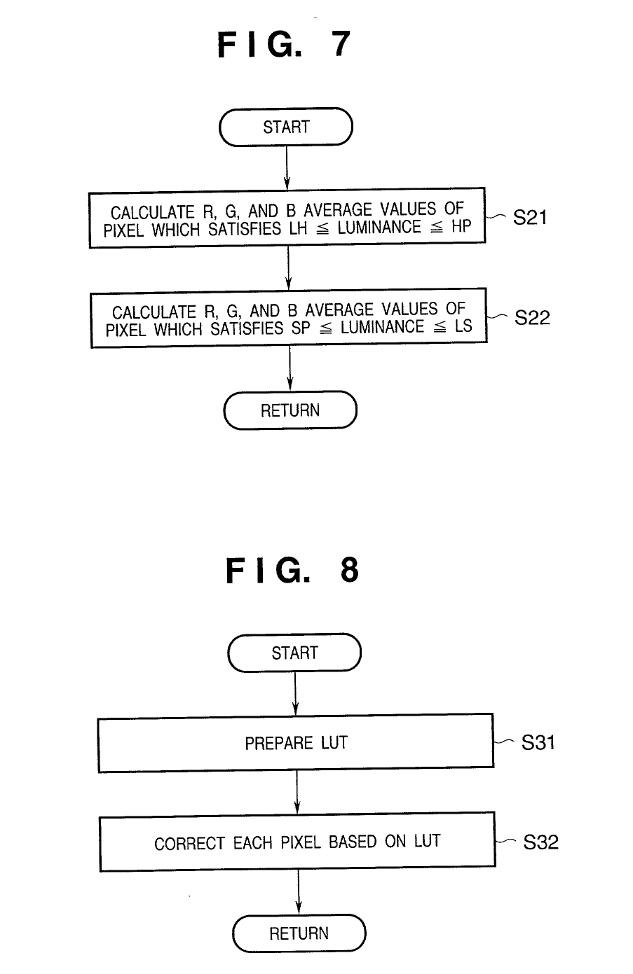

In step S4, the white/black balance calculation block 9 calculates the white and black balances of the image data stored in the image buffer 4. Note that the operation of the white/black balance calculation block 9 will be described in detail later with reference to FIG. 7.

In step S5, the image correction block 10 loads the image from the image buffer 4, corrects it in units of pixels, and writes the corrected image again in the image buffer 4. Note that the operation of the image correction block 10 will be described in detail later with reference to FIG. 8.

In step S6, the saturation calculation block 11 loads the image from the image buffer 4 and calculates saturation values in units of pixels. Also, the saturation parameter setting block 12 determines saturation parameters on the basis of the calculated saturation values, and stores them in the parameter holding block 5. Furthermore, the saturation conversion block 13 corrects saturation in units of pixels on the basis of the saturation conversion parameters stored in the parameter holding block 5, and writes the corrected image again in the image buffer. Note that such saturation correction processes will be explained in detail later with reference to FIG. 10.

In step S7, the image output block 3 reads out the image data stored in the image buffer 4, and outputs it as an output image 14.

[Parameter]

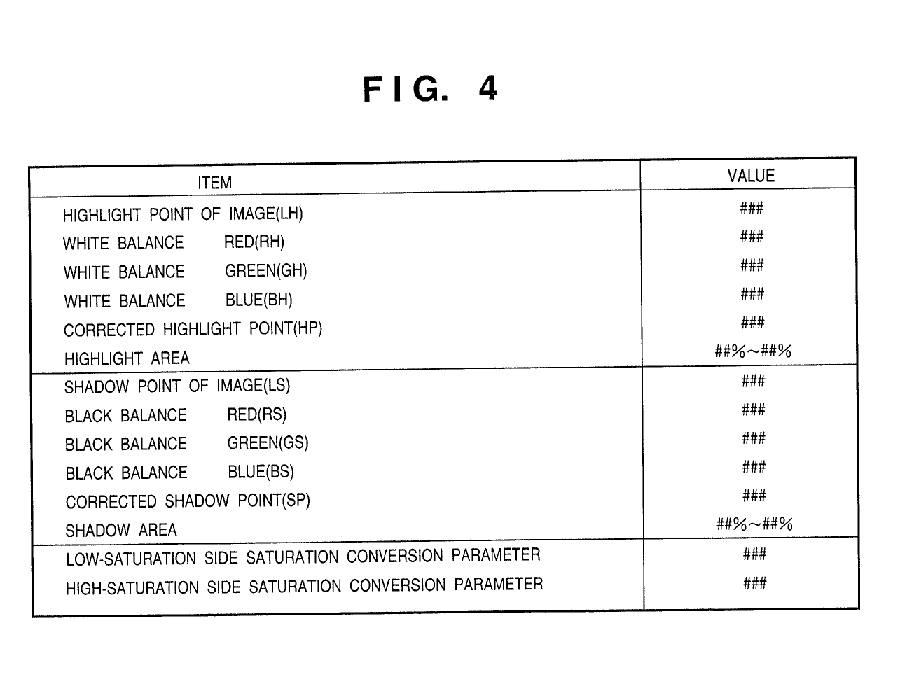

The parameters stored in the parameter holding block 5 will be explained below. FIG. 4 shows register items in the parameter holding block. Referring to FIG. 4, as parameters for white balance adjustment, a highlight point (LH) of image data, white balance values (RH, GH, BH) for red, green, and blue, a corrected highlight point (HP), and a highlight area value are held. Likewise, as parameters for black balance adjustment, a shadow point (LS) of image data, black balance values for red, green, and blue, a corrected shadow point (SP), and a shadow area value are held.

To implement saturation conversion, a low-saturation side saturation conversion parameter, and a high-saturation side saturation conversion parameter are held.

In the initial state of this embodiment, these parameters are initialized to appropriate values. For example, “245” is set as the corrected highlight point (HP), and “10” is set as the corrected shadow point (SP). Note that in this embodiment the highlight area ranges from 99 to 100%, and the shadow area from 0 to 1%. Also, for example, the low-saturation side saturation conversion parameter is initialized to “40”, and the high-saturation side saturation conversion parameter is initialized to “20”.

[Highlight/Shadow Calculation Process]

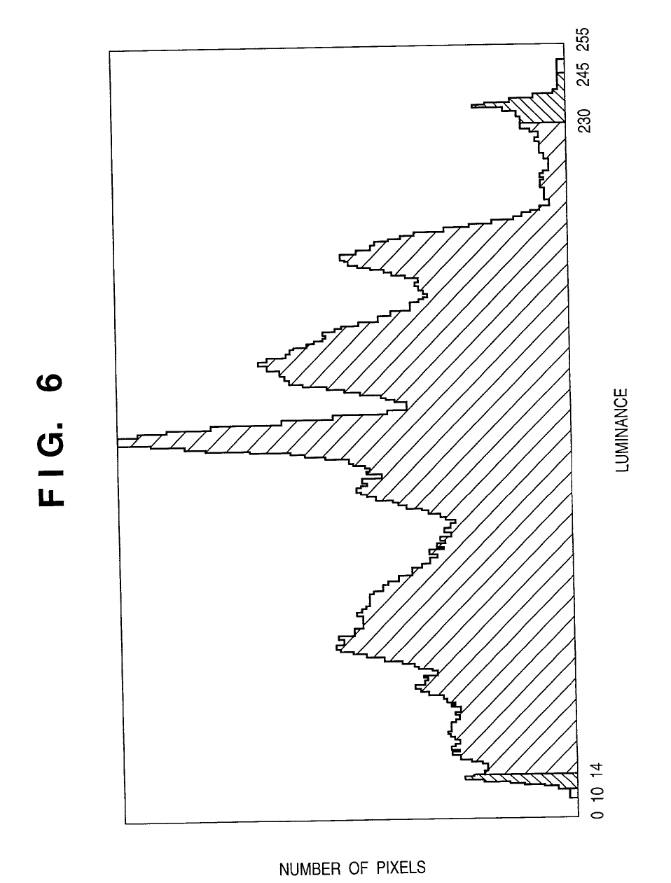

FIG. 5 is a flow chart showing the highlight/shadow calculation process in the highlight/shadow calculation block 8. That is, FIG. 5 shows the contents of step S3 in FIG. 3 in detail. FIG. 6 shows an example of the luminance histogram generated in step S2 in FIG. 3.

In step S12, a highlight point LH of the image is calculated on the basis of the luminance histogram shown in FIG. 6. Note that the highlight point LH is the lowest luminance value in the highlight area of the image. Hence, in the luminance histogram example shown in FIG. 6, since the luminance range corresponding to the highlight area (99 to 100%) ranges from 230 to 255, the highlight point LH is “230”. This result is stored in the parameter holding block 5.

In step S13, a shadow point LS of the image is calculated on the basis of the luminance histogram shown in FIG. 6. Note that the shadow point LS is a highest luminance value in the shadow area of the image. Hence, in the luminance histogram example shown in FIG. 6, since the luminance range corresponding to the shadow area (0 to 1%) ranges from 0 to 14, the shadow point LS is “14”. This result is stored in the parameter holding block 5.

[White/black Balance Calculation Process]

FIG. 7 is a flow chart showing the white/black balance calculation process in the white/black balance calculation block 9. That is, FIG. 7 shows the contents of step S4 in FIG. 3 in detail.

In step S21, white balance values are calculated. More specifically, image data is loaded from the image buffer 4 in units of pixels, and R, G, and B average luminance values (white balance values) of pixels whose luminance values are equal to or higher than the highlight point LH and equal to or lower than a corrected highlight point HP are calculated. In the luminance histogram example shown in FIG. 6, pixels whose luminance values fall within the area ranging from LH=230 to HP=245 undergo this process. The obtained average values are stored in corresponding registers RH, GH, and BH of the parameter holding block 5.

In step S22, black balance values are calculated. More specifically, image data is loaded from the image buffer 4 in units of pixels, and R, G, and B average luminance values (black balance values) of pixels whose luminance values are equal to or higher than a corrected shadow point SP and equal to or lower than the shadow point LS are calculated. In the luminance histogram example shown in FIG. 6, pixels whose luminance values fall within the area ranging from SP=10 to LS=14 undergo this process. The obtained average values are stored in corresponding registers RS, GS, and BS of the parameter holding block 5.

[Image Correction Process]

FIG. 8 is a flow chart showing the image correction process in the image correction block 10. That is, FIG. 8 shows the contents of step S5 in FIG. 3 in detail.

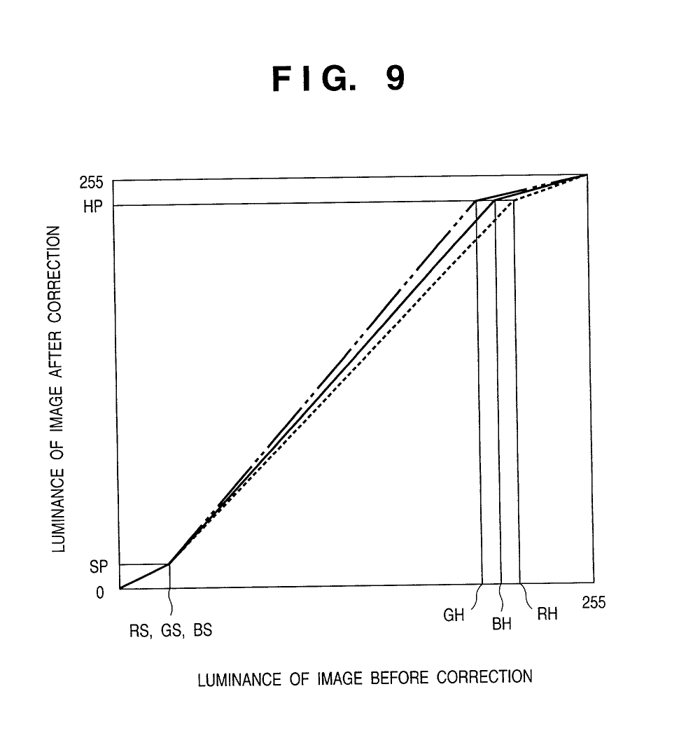

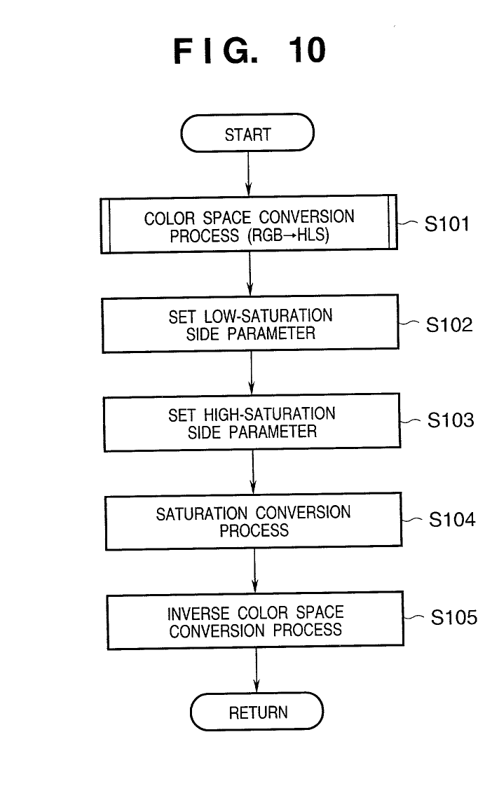

In step S31, a look-up table (LUT) is prepared on the basis of the white balance values (RH, GH, BH) of the individual colors, highlight point HP, black balance values (RS, GS, BS), and shadow point LS held in the parameter holding block 5. FIG. 9 shows an example of the prepared LUT. In the LUT shown in FIG. 9, the highlight portion has steeper gamma correction characteristics in the order of G, B, and R. In this way, by emphasizing G and B with respect to R, so-called color tint of an image tinged with blue (blue cast) can be corrected.

In step S32, the image data stored in the image buffer 4 is corrected in units of pixels on the basis of the prepared LUT.

[Saturation Conversion Process]

FIG. 10 is a flow chart showing the saturation conversion process as the characteristic feature of this embodiment. This process shows the contents of step S6 in FIG. 3 in detail, and is implemented by the saturation calculation block 11, saturation conversion parameter setting block 12, and saturation conversion block 13.

Color Space Conversion Process

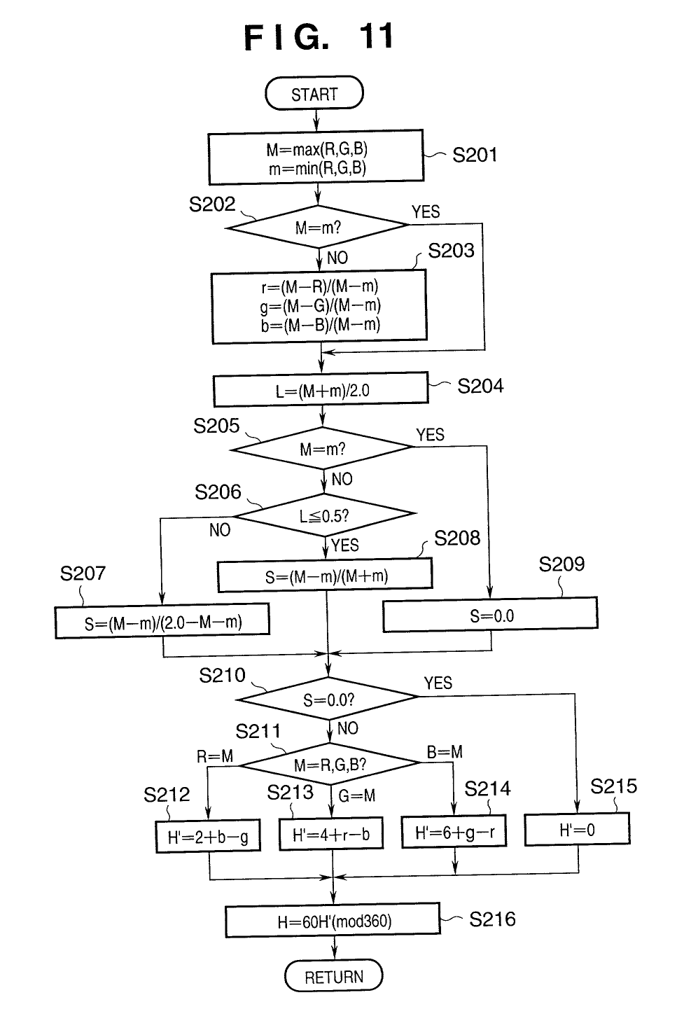

In step S101, the saturation calculation block 11 converts image data expressed in the RGB color space into HLS data in the HLS color space indicating hue, lightness, and saturation. FIG. 11 is a flow chart showing the process for converting RGB data into HLS data in units of pixels, and this process will be explained below. Note that the present invention is not limited to such specific saturation calculation method, and other methods may be used.

Referring to FIG. 11, a maximum value M and minimum value m of R, G, and B color component data of the pixel of interest are obtained (S201). The obtained maximum and minimum values M and m are compared (step S202). If the two values are equal to each other, i.e., if R=G=B and the pixel of interest has achromatic color, the flow advances to step S204. If the two values are not equal to each other, the following values are calculated in step S203:

r=(M−R)/(M−m)

g=(M−G)/(M−m)

b=(M−B)/(M−m)

In step S204, lightness L is calculated by:

L=(M+m)/2.0

It is checked if the pixel of interest is achromatic color or if lightness L is equal to or lower than a predetermined value (0.5) if the pixel of interest is not achromatic color (S205, S206), and saturation S is calculated according to the discrimination result by (S207 to S209):

| | |
|---|---|
| Achromatic color | S = 0 |
| Chromatic color L ≦ 0.5 | S = (M − m) / (M + m) |
| Chromatic color L > 0.5 | S = (M − m) / (2.0 − M − m) |

It is then checked if the pixel of interest is achromatic color or which color component the maximum value M corresponds to if the pixel of interest is not achromatic color (S210, S211), and hue H is calculated according to the discrimination result by (S212 to S216):

| | |
|---|---|
| Achromatic color | H′ = 0 |
| Chromatic color R = M | H′ = 2 + b − g |
| Chromatic color G = M | H′ = 4 + r − b |
| Chromatic color B = M | H′ = 6 + g − r |
| H = 60H′ (mod360) | |

Note that the hue of achromatic color is defined to be zero in this embodiment.

As described above, the conversion process shown in FIG. 11 converts RGB data indicating one pixel into HLS data including hue H ranging from 0° to 360° (blue: 0°, red: 120°, green: 240°), lightness L ranging from 0.0 to 1.0 (black to white), and saturation S ranging from 0.0 to 1.0 (achromatic color to most vivid color for certain saturation).

Saturation Conversion Parameter Setup and Saturation Conversion Process

In steps S102 and S103 in FIG. 10, the saturation conversion parameter setting block 12 determines appropriate low- and high-saturation side conversion parameters on the basis of the average value, intermediate value, variance, and the like of saturation information of the HLS data, and stores them in the parameter holding block 5.

Note that the saturation conversion parameters may be directly set by user instruction. That is, the user may change the parameters set by the saturation conversion parameter setting block 12 via the keyboard I/F 109.

The saturation conversion parameters are determined in correspondence with the average value, intermediate value, variance, or the like of saturation information of HLS data. Alternatively, pre-set values may be set as parameters independently of saturation information.

Furthermore, when a plurality of parameters are held in advance as a table, appropriate parameters can be selected based on R, G, and B values without any saturation conversion of the R, G, and B values of each pixel.

This embodiment will exemplify a case wherein the low- and high-saturation side conversion parameters are respectively set at “40” and “20”.

In step S104, the saturation conversion block 13 performs saturation conversion of HLS data of an original image on the basis of the saturation conversion parameters set in steps S102 and S103.

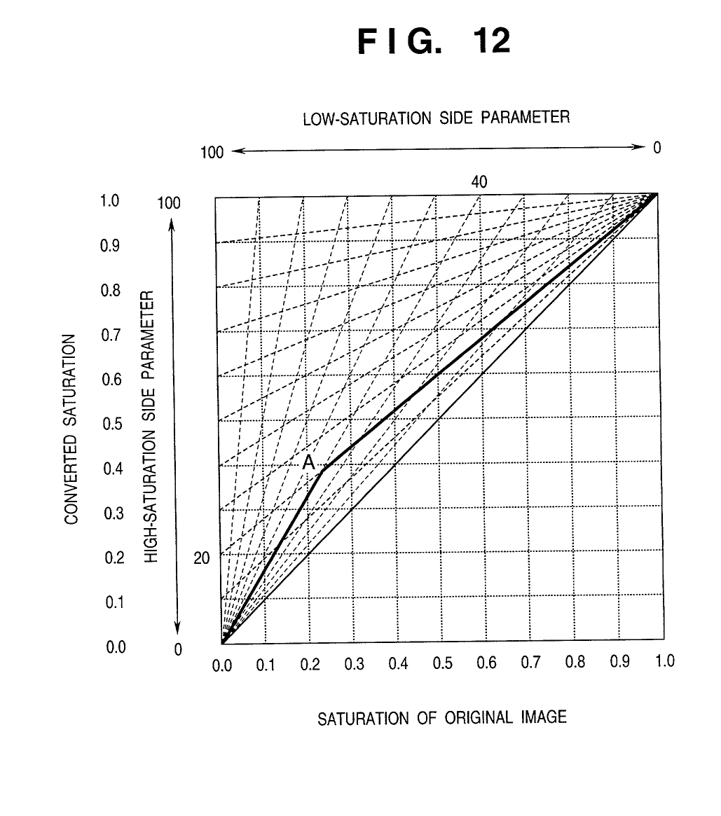

Setups of these two saturation conversion parameters and details of the saturation conversion process using these parameters will be explained below with reference to FIG. 12.

FIG. 12 is a graph showing the saturation conversion characteristics in this embodiment. The abscissa plots the saturation values (0.0 to 1.0) of an original image, and the ordinate plots the converted saturation values (0.0 to 1.0). The abscissa and ordinate respectively also plot low- and high-saturation side conversion parameters, which respectively assume values ranging from 0 to 100, and correspond to conversion lines.

In FIG. 12, if the lower left point of the graph that corresponds to saturation=0.0 of the original image and to converted saturation=0.0 is defined as an origin, for example, a low-saturation side parameter=“0” means a line that connects the origin (0.0, 0.0) and the upper right point (1.0, 1.0) of the graph, and a low-saturation side parameter=“100” means a line that connects the origin (0.0, 0.0) and the upper left point (0.0, 1.0) of the graph. By equally dividing each line into 100 sections, lines corresponding to low-saturation side parameter values ranging from 0 to 100 can be obtained.

On the other hand, a high-saturation side parameter=“0” means a line that connects the upper right point (1.0, 1.0) of the graph and the origin (0.0, 0.0), and a high-saturation side parameter=“100” means a line that connects the upper right point (1.0, 1.0) of the graph and the upper left point (0.0, 1.0) of the graph. By equally dividing each line into 100 sections, lines corresponding to high-saturation side parameter values ranging from 0 to 100 can be obtained.

Hence, the low-saturation side saturation conversion parameter=“40” set in step S102 indicates a line that connects the origin (0.0, 0.0) and a point (0.6, 1.0), and the high-saturation side saturation conversion parameter=“20” set in step S103 indicates a line that connects the upper right point (1.0, 1.0) of the graph and a point (0.0, 0.2).

Based on these two conversion lines corresponding to the low- and high-saturation side conversion parameters, saturation conversion characteristics actually used in the saturation conversion process are calculated. In FIG. 12, these two lines cross at point A. Hence, in step S104, a line that connects the origin (0.0, 0.0), point A, and the upper right point (1.0, 1.0) of the graph is calculated as the saturation conversion characteristics, and the saturation (S) component of the HLS data converted in step S101 undergoes saturation conversion based on the calculated characteristics. According to the saturation conversion characteristics, the converted saturation neither becomes 0.0 (achromatic color) nor is saturated at 1.0.

In this manner, since different saturation parameters can be set at the low- and high-saturation sides, oversaturation or undersaturation due to saturation conversion can be avoided, and appropriate saturation correction can be achieved at both sides. Note that the saturation conversion characteristics shown in FIG. 12 may be pre-stored in, e.g., the ROM 101, or may be stored in the RAM 103, storage unit 8, or the like so that they can be updated.

Inverse Color Space Conversion Process

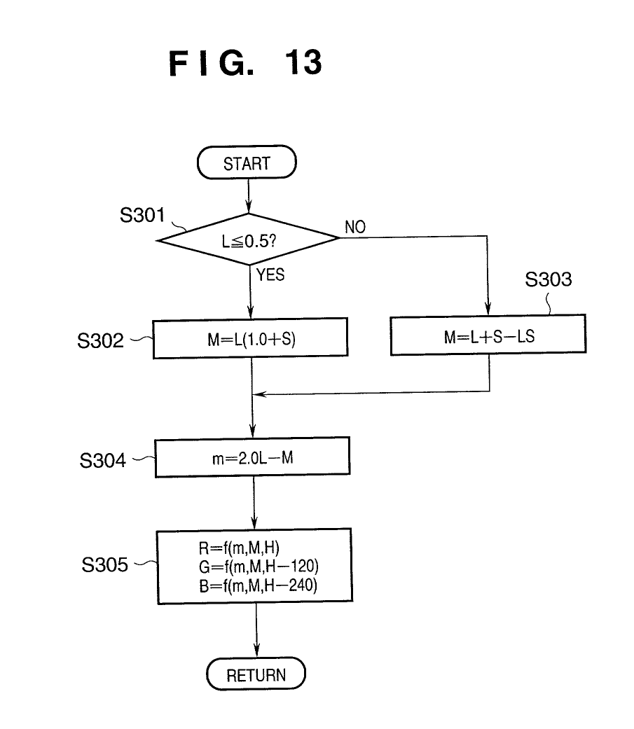

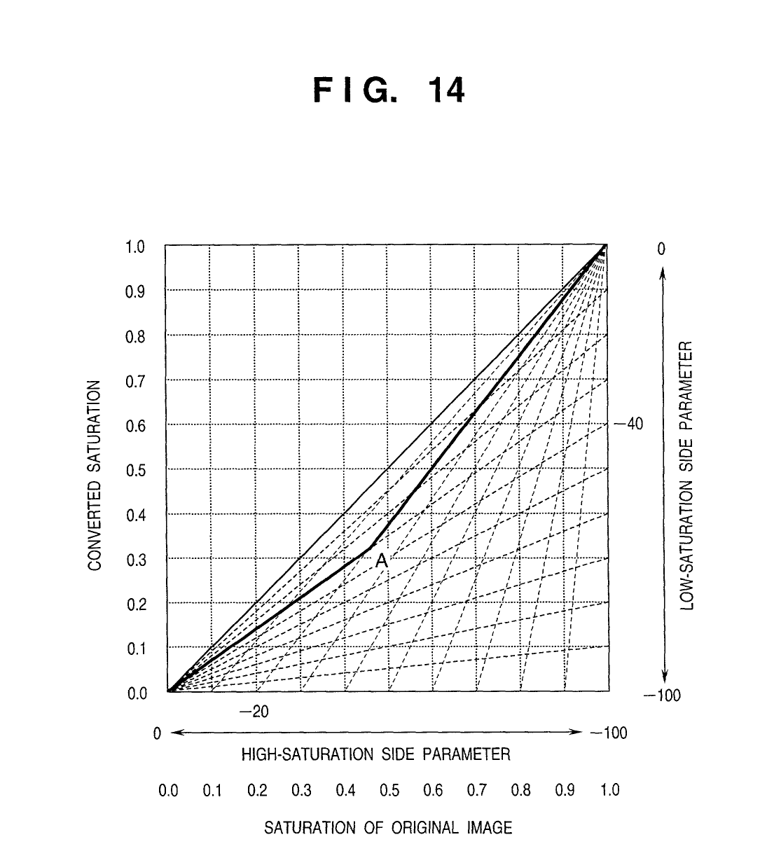

After the HLS data has undergone saturation conversion, the saturation calculation block 11 inversely converts the saturation-converted HLS data into RGB data in step S105 in FIG. 10. FIG. 13 is a flow chart showing the inverse conversion process from HLS data into RGB data, and this process will be explained below.

Referring to FIG. 13, it is checked if a lightness value L is equal to or higher than a predetermined value (0.5) (S301). If YES in step S301, parameter M=L(1.0+S) is set (S302); otherwise, M=L+S−LS is set (S303). After parameter m=2.0L−M is set (S304), R, G, and B color component values are calculated using a function f(m, M, h) by (S305):

R=f(m, M, H)

G=f(m, M, H−120)

B=f(m, M, H−240)

Note that depending on the value h, the function f(m, M, h) is determined by:

| | |
|---|---|
| 0 ≦ h < 60 | f(m, M, h) = m + (M − m) h/60 |
| 60 ≦ h < 180 | f(m, M, h) = M |
| 180 ≦ h < 240 | f(m, M, h) = m + (M − m) (240 − h) /60 |
| 240 ≦ h < 360 | f(m, M, h) = m |

Note that if h is a negative value, a value obtained by adding 360 to h is referred to.

In this manner, the saturation-converted HLS data is inversely converted into RGB data, and the converted data is held in the buffer 4. Then, the RGB data is output as an output image 14 (S7).

In this embodiment, the low-saturation side saturation conversion parameter is set at “40”, and the high-saturation side saturation conversion parameter is set at “20”. However, the present invention is not limited to such specific parameter values, and any other values may be set if they fall within an allowable setting range (0 to 100 in the above embodiment).

Also, as shown in FIG. 12, in this embodiment, the saturation conversion parameters correspond to saturation conversion lines. However; the saturation conversion characteristics of the present invention are not limited to lines but may be defined by curves. That is, appropriate lines or curves need only be set as saturation conversion characteristics so as to achieve appropriate saturation conversion.

As described above, according to this embodiment, since the saturation conversion characteristics can be varied at the low- and high-saturation sides, flexible saturation conversion can be attained. Therefore, chromatic color can be prevented from becoming achromatic at the low-saturation side or being saturated at the high-saturation side as a result of saturation conversion.

When a plurality of saturation conversion parameters can be set in correspondence with the saturation of an image, appropriate saturation conversion can be made in correspondence with the saturation of the image.

<Modification>

In the above embodiment, the method of calculating the conversion characteristics for increasing saturation has been explained with reference to FIG. 12. Likewise, conversion characteristics for decreasing saturation can be calculated. FIG. 14 shows an example of the conversion characteristics upon decreasing saturation, and a case will be exemplified below wherein the low- and high-saturation side saturation conversion parameters are respectively set at “−40” and “−20”.

FIG. 14 is a graph showing the saturation conversion characteristics in this modification. In FIG. 14, the abscissa plots the saturation values (0.0 to 1.0) of an original image, and the ordinate plots the converted saturation values (0.0 to 1.0). The abscissa and ordinate respectively also plot high- and low-saturation side conversion parameters, which respectively assume values ranging from 0 to 100, and correspond to conversion lines.

In FIG. 14, if the lower left point of the graph that corresponds to saturation=0.0 of the original image and to converted saturation=0.0 is defined as an origin, for example, a low-saturation side parameter=“0” means a line that connects the origin (0.0, 0.0) and the upper right point (1.0, 1.0) of the graph, and a low-saturation side parameter=“−100” means a line that connects the origin (0.0, 0.0) and the lower right point (1.0, 0.0) of the graph. By equally dividing each line into 100 sections, lines corresponding to low-saturation side parameter values ranging from 0 to −100 can be obtained.

On the other hand, a high-saturation side parameter=“0” means a line that connects the upper right point (1.0, 1.0) and the origin (0.0, 0.0) of the graph, and a high-saturation side parameter=“−100” means a line that connects the upper right point (1.0, 1.0) and the lower right point (1.0, 0.0) of the graph. By equally dividing each line into 100 sections, lines corresponding to high-saturation side parameter values ranging from 0 to −100 can be obtained.

Hence, when the low-saturation side saturation conversion parameter is, e.g., “−40”, it indicates a line that connects the origin (0.0, 0.0) and a point (1.0, 0.6), and when the high-saturation side saturation conversion parameter is, e.g., “−20”, it indicates a line that connects the upper right point (1.0, 1.0) and a point (0.2, 0.0) of the graph.

Based on these two conversion lines corresponding to the low- and high-saturation side conversion parameters, saturation conversion characteristics actually used in the saturation conversion process are calculated. In FIG. 14, these two curves cross at point A. Hence, a line that connects the origin (0.0, 0.0), point A, and the upper right point (1.0, 1.0) of the graph is calculated as the saturation conversion characteristics, and saturation conversion is done based on the calculated characteristics. According to the saturation conversion characteristics, the converted saturation neither becomes 0.0 (achromatic color) nor is saturated at 1.0 in the chromatic color area of an original image.

In this manner, in the saturation conversion process for decreasing saturation as well, the saturation conversion characteristics can be varied at the low- and high-saturation sides, and flexible saturation conversion can be achieved.

[Other Embodiments]

Note that the present invention may be applied to either a system constituted by a plurality of devices (e.g., a host computer, an interface device, a reader, a printer, and the like), or an apparatus consisting of a single equipment (e.g., a copying machine, a facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

When the present invention is applied to the storage medium, that storage medium stores program codes corresponding to the aforementioned flow charts (FIGS. 3, 5, 7, 8, 10, 11, and 13).

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
saturation calculation means for calculating saturation information of an image;
parameter setting means for setting a plurality of parameters used to convert saturation of the image; and
saturation conversion means for converting the saturation of the image on the basis of the plurality of parameters.

2. The apparatus according to claim 1, wherein said parameter setting means sets the parameters for low- and high-saturation sides of the image.

3. The apparatus according to claim 1, wherein said parameter setting means sets the parameters on the basis of the saturation information of the image.

4. The apparatus according to claim 1, further comprising:
instruction means for making an instruction input by a user, and wherein
said parameter setting means sets the parameters on the basis of the instruction by said instruction means.

5. The apparatus according to claim 2, wherein said saturation conversion means determines saturation conversion characteristics on the basis of the plurality of parameters, and converts the saturation of the image on the basis of the saturation conversion characteristics.

6. The apparatus according to claim 5, wherein said saturation conversion means determines saturation conversion characteristics on the high- and low-saturation sides of the image on the basis of the plurality of parameters.

7. The apparatus according to claim 6, wherein the saturation conversion characteristics exhibit a monotonous increase.

8. The apparatus according to claim 6, wherein the saturation conversion characteristics exhibit a monotonous decrease.

9. The apparatus according to claim 1, wherein said saturation calculation means calculates the saturation information of the image by converting the image expressed in a first color space into a second color space.

10. The apparatus according to claim 9, wherein said saturation calculation means further converts the image, which has undergone saturation conversion in the second color space by said saturation conversion means, into the first color space.

11. The apparatus according to claim 9, wherein the first color space is an RGB color space, and the second color space is an HLS color space.

12. The apparatus according to claim 1, further comprising:
detection means for detecting a color distribution of the image;
generation means for generating gradation correction information of the image on the basis of the color distribution; and
gradation correction means for performing gradation correction of the image on the basis of the gradation correction information.

13. The apparatus according to claim 12, wherein said saturation conversion means performs saturation conversion for an image which has undergone the gradation correction by said gradation correction means.

14. The apparatus according to claim 12, wherein said generation means comprises:
highlight calculation means for calculating highlight area information of an image on the basis of the color distribution; and
white balance calculation means for calculating white balance information on the basis of the highlight area information and a predetermined highlight value, and
said gradation correction means corrects gradation of the image on the basis of the white balance information and the highlight value.

15. The apparatus according to claim 12, wherein said generation means comprises
shadow calculation means for calculating shadow area information of an image; and
black balance calculation means for calculating black balance information on the basis of the shadow area information and a predetermined shadow value, and
said gradation correction means corrects gradation of the image on the basis of the black balance information and the shadow value.

16. An image processing method comprising:
the saturation calculation step of calculating saturation information of an image;
the parameter setting step of setting a plurality of parameters used to convert saturation of the image; and
the saturation conversion step of converting the saturation of the image on the basis of the plurality of parameters.

17. The method according to claim 16, wherein the parameter setting step includes the step of setting the parameters for low- and high-saturation sides of the image.

18. The method according to claim 16, wherein the parameter setting step includes the step of setting the parameters on the basis of the saturation information of the image.

19. A recording medium comprising program codes of an image processing method at least comprising:
a code of the saturation calculation step of calculating saturation information of an image;
a code of the parameter setting step of setting a plurality of parameters used to convert saturation of the image; and
a code of the saturation conversion step of converting the saturation of the image on the basis of the plurality of parameters.
